(19) United States
(12) Patent Application Publication
(10) Pub. No.: US 2025/0085708 A1
(43) Pub. Date: Mar. 13, 2025

(54) SYSTEM AND METHOD TO IMPROVE PRECISION AND RECALL OF PROTOTYPICAL NETWORKS FOR SOUND EVENT DETECTION

(71) Applicant: Robert Bosch GmbH, Stuttgart (DE)

(72) Inventors: Md Ehsanul Haque Nirjhar, College Station, TX (US); Luca Bondi, Pittsburgh, PA (US); Shabnam Ghaffarzadegan, Livermore, CA (US); Samarjit Das, Wexford, PA (US)

(21) Appl. No.: 18/244,029

(22) Filed: Sep. 8, 2023

(51) Int. Cl. G05D 1/02; G05B 13/02

(52) U.S. Cl. CPC G05D 1/0255; G05B 13/027

(57) ABSTRACT

A method of training a prototypical network for sound event detection includes receiving samples of an audio signal that include positive samples corresponding to sound events and negative samples that do not correspond to sound events, determining, based on the positive samples, respective positive prototypes of a plurality of classes of sound events, determining, based on the negative samples, respective negative prototypes for respective groups of the negative samples, each of the negative prototypes corresponding to a combination of a plurality of the negative samples, and generating, based on comparisons between a first sample and the respective positive prototypes and each of the negative prototypes, an output signal that indicates whether the first sample belongs to one of the plurality of classes of sound events.

### TECHNICAL FIELD

The present disclosure relates to sound event detection (SED), and more particularly to systems and methods of operating devices that implement SED.

### BACKGROUND

Sound event detection (SED) refers to the task of recognizing and differentiating individual acoustic events (e.g., birds chirping, gunshot sounds, smoke alarm ringing, etc.) within a continuous audio stream. SED involves detecting the occurrence of a given event, as well as identifying the onset and offset timestamps.

SED is challenged compared to other matured areas in acoustic signal processing, such as automatic speech recognition (ASR). ASR deals with spoken language, where sound events are constrained by the human vocal tract morphology, while SED deals with acoustic events that are more diverse (e.g., both periodic and sporadic in nature). The domain of SED tasks ranges from domestic and large-scale security surveillance to bio-acoustic event detection in-the-wild.

### SUMMARY

A method of training a prototypical network for sound event detection includes receiving samples of an audio signal that include positive samples corresponding to sound events and negative samples that do not correspond to sound events, determining, based on the positive samples, respective positive prototypes of a plurality of classes of sound events, determining, based on the negative samples, respective negative prototypes for respective groups of the negative samples, each of the negative prototypes corresponding to a combination of a plurality of the negative samples, and generating, based on comparisons between the first sample and the respective positive prototypes and each of the negative prototypes, an output signal that indicates whether a first sample belongs to one of the plurality of classes of sound events.

In other features, the method further includes obtaining first embeddings of the positive samples and second embeddings of the negative samples, determining the respective positive prototypes based on the first embeddings, and determining the respective negative prototypes based on the second embeddings. Determining the respective negative prototypes includes determining a negative prototype for each of the respective groups of the negative samples. The method further includes determining, based on the comparisons, at least one probability that the first sample corresponds to the one of the plurality of classes of sound events, and generating the output based on the at least one probability. The method further includes determining at least one probability distribution and generating the output based on the at least one probability distribution. The method further includes determining at least one threshold based on the at least one probability distribution and generating the output based on a comparison between the at least one probability and the at least one threshold. Determining the at least one threshold includes determining the at least one threshold based on a first probability distribution of probabilities that the positive samples belong to a respective classes of the plurality of classes of sound events and a second distribution of probabilities that the negative samples belong to respective classes of the plurality of classes of sound events.

A computing device configured to train a prototypical network for sound event detection includes a processing device configured to execute instructions stored in memory to receive samples of an audio signal, the samples including positive samples corresponding to sound events and negative samples that do not correspond to sound events, determine, based on the positive samples, respective positive prototypes of a plurality of classes of sound events, determine, based on the negative samples, respective negative prototypes for respective groups of the negative samples, each of the negative prototypes corresponding to a combination of a plurality of the negative samples, and generate, based on comparisons between the first sample and the respective positive prototypes and each of the negative prototypes, an output signal that indicates whether a first sample belongs to one of the plurality of classes of sound events.

In other features, the processing device is further configured to execute the instructions to obtain first embeddings of the positive samples and second embeddings of the negative samples, determine the respective positive prototypes based on the first embeddings, and determine the respective negative prototypes based on the second embeddings. Determining the respective negative prototypes includes determining a negative prototype for each of the respective groups of the negative samples. The processing device is further configured to execute the instructions to determine, based on the comparisons, at least one probability that the first sample corresponds to the one of the plurality of classes of sound events, and generate the output based on the at least one probability. The processing device is further configured to execute the instructions to determine at least one probability distribution and generate the output based on the at least one probability distribution. The processing device is further configured to execute the instructions to determine at least one threshold based on the at least one probability distribution, and generate the output based on a comparison between the at least one probability and the at least one threshold. Determining the at least one threshold includes determining the at least one threshold based on a first probability distribution of probabilities that the positive samples belong to respective classes of the plurality of classes of sound events and a second distribution of probabilities that the negative samples belong to respective classes of the plurality of classes of sound events.

A computer-controlled machine includes at least one sensor configured to generate an audio signal, a control system configured to receive a first sample of the audio signal and generate, based on comparisons between the first sample and respective positive prototypes for each of a plurality of classes of sound events and respective negative prototypes for each of a plurality of groups of negative prototypes, an output signal that indicates whether the first sample of the audio signal belongs to one of the plurality of classes of sound events, and an actuator configured to control an operation of the computer-controlled machine in response to the output of the control system.

In other features, the computer-controlled machine further includes memory that stores the respective positive prototypes and the respective negative prototypes. The respective positive prototypes correspond to a plurality of positive samples and each of the respective negative prototypes corresponds to a combination of a plurality of negative samples. Generating the output includes calculating a probability that the first sample belongs to a first class of the plurality of classes or a first group of the plurality of groups. Generating the output includes comparing the probability to at least one threshold and generating the output based on the comparison. The at least one threshold includes a plurality of thresholds corresponding to respective classes of the plurality of classes of sound events. The computer-controlled machine includes an autonomous robot.

### BRIEF DESCRIPTION OF THE DRAWINGS

FIG. 1 generally illustrates a system for training a neural network according to the principles of the present disclosure.

FIG. 2 generally illustrates a computer-implemented method for training and utilizing a neural network according the principles of the present disclosure.

FIG. 3A generally illustrates an audio data labeling system according to the principles of the present disclosure.

FIG. 3B generally illustrates a portion of a data capturing system according to the principles of the present disclosure.

FIG. 3C generally illustrates an alternative audio data labeling system, according to the principles of the present disclosure.

FIG. 4A generally illustrates an example audio stream including a support set and a query set according to the principles of the present disclosure.

FIG. 4B generally illustrates positive and negative set clustering of samples according to the principles of the present disclosure.

FIG. 4C generally illustrates example clustering of support sets according to the principles of the present disclosure.

FIG. 4D generally illustrates an example of the probability distributions obtained from positive support set samples and negative support set samples according to the principles of the present disclosure.

FIG. 4E generally illustrates example probability calculations according to the principles of the present disclosure

FIG. 4F generally illustrates an example method for determining a class of a sample x_{q} according to the principles of the present disclosure.

FIG. 5 depicts a schematic diagram of an interaction between a computer-controlled machine and a control system according to the principles of the present disclosure.

FIG. 6 depicts a schematic diagram of the control system of FIG. 5 configured to control a vehicle, which may be a partially autonomous vehicle, a fully autonomous vehicle, a partially autonomous robot, or a fully autonomous robot, according to the principles of the present disclosure.

FIG. 7 depicts a schematic diagram of the control system of FIG. 5 configured to control a manufacturing machine, such as a punch cutter, a cutter or a gun drill, of a manufacturing system, such as part of a production line.

FIG. 8 depicts a schematic diagram of the control system of FIG. 5 configured to control a power tool, such as a power drill or driver that has an at least partially autonomous mode.

FIG. 9 depicts a schematic diagram of the control system of FIG. 5 configured to control an automated personal assistant.

FIG. 10 depicts a schematic diagram of the control system of FIG. 5 configured to control a monitoring system, such as a control access system or a surveillance system.

FIG. 11 depicts a schematic diagram of the control system of FIG. 5 configured to control an imaging system, for example an MRI apparatus, x-ray imaging apparatus or ultrasonic apparatus.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

Sound event detection (SED) is a challenging task due to the existence of both target sound and non-target sounds in the environment. Proper labels of the target sound is necessary for machine learning models to detect the sound events from an audio stream. However, these models often require a large amount of labeled data and application-specific fine-tuning of models. Further, collecting labels of the target sound events within large audio collections needs expert raters (e.g., to obtain annotations for long audio recordings, label the start and end timestamps of each event, etc.), especially when the events are from a specific domains (e.g., wildlife, machinery, security surveillance), adding to the challenges in the annotation process. Thus, SED can be costly and time-consuming.

Prototypical networks gained popularity in recent years by leveraging a small amount of labeled samples per class (i.e., to train deep learning SED models with less data), while showing competitive recall rates in SED, which may be referred. However, these models often fail to differentiate between target and non-target sounds due to the variety of background noise and soundscape. Further, these models did not aim to detect rare or previously unseen events during inference time.

Few-shot learning methods may be successful in cases where previously unseen classes can be inferred with only few labeled samples. Several computer vision problems greatly benefit by the use of few-shot learning methods (e.g., prototypical networks, matching networks, twin networks, etc.) Some recent examples framed the SED tasks with few labeled samples as a few-shot learning task, where models are trained in an N-way K-shot formulation in an episodic manner. At training time, the model learns an embedding representation on N classes in an episodic fashion, where each episode uses only K labeled samples from each class to build N prototypes and classify the input samples.

For example, when a new audio sequence containing events from unseen classes is provided, the first part of the sequence is manually labeled (“support set”), while the remaining part of the sequence is used for inference (“query set”). The model labels the query set using information from the support set, the support set having at least K labeled samples for each new class. Prototypical networks are the best performing model for few-shot SED tasks, where the model automatically finds the onset and offset timestamps of events belonging to a class unknown during training in a long audio sequence, given that the first K occurrences of that class are labeled in the support set. The model learns a positive prototype representative of the class of interest, along with a corresponding negative prototype, and performs a binary classification at the inference time for each one of the classes presented in the support set.

Systems and methods according to the principles of the present disclosure identify and improve various aspects of SED systems. For example, while building prototypes, more focus is typically given towards creating positive prototypes using the support set, while negative prototypes are constructed by random sampling of segments from the whole audio sequence. Although this method reduces human effort in terms of providing explicit labels for negative samples, it assumes that the target sound events are very sparse in the sequence. This may not always be the case, and can result in unreliable negative prototypes built on top of randomly picked positive samples. In addition, only classes of target sound events are typically used while training, preventing the model from learning a proper representation for background (i.e., non-target) sounds, as the background is often more diverse compared to the target sounds in the support set. However, a single negative prototype might not provide a proper representation of the non-target sounds during inference, as there may exist multiple clusters of negative samples that would naturally form different negative prototypes.

SED tasks further includes a step of determining the onset and offset timestamps of target sounds using a threshold on the output predictions. Conventional SED systems use a fixed value for the decision threshold, which might not be suitable for all audio queries due to diverse background and events. In the context of prototypical networks applied to SED tasks, systems and methods according to the present disclosure (i) implement an explicit inclusion of non-target sounds during training to learn a background-aware embedding representation; (ii) construct the negative prototype at inference using the non-target portions of the support set instead of random sampling from the whole audio sequence (support and query sets); (iii) incorporate clustering on the negative samples of the support set at inference time to accommodate for variability in non-target sounds; and (iv) implement a leave-one-sample-out cross validation on the support set to automatically identify the decision threshold value that would provide the best separation between background and events of interest.

Few shot learning is a sub-domain of meta-learning which essentially explores how machines “learn to learn” and tries to mimic human capacity to learn a new concept with the exposure to very few examples. This can be very useful in detecting sound events that are less frequent or rare, compared to their background. The use of few-shot learning takes out the burden of collecting large number of labeled samples of such infrequent sound events. Models trained with regular sound events (i.e., a training set) can be tuned to identify these infrequent events with few examples (i.e., a support set). Models typically trained in a fully-supervised fashion can be tuned to identify these infrequent events with few examples from a support set.

Although few-shot learning has been widely used in computer vision, it has recently gained interest in the audio research domain. Several few-shot learning methods (e.g., twin, matching, prototypical, and relation networks) have been explored for sound event detection in an English speech corpora by formulating the problem as N-way K-shot problem. In some examples, four standard convolutional blocks were used as an embedding network prior to the few-shot networks. Results of these examples suggested that prototypical networks outperformed other few-shot methods at inference time when K positive samples are available for the test data, and the complete audio data is used to generate negative examples for support set through random sampling.

A similar approach is used to generate the support set in other examples, which also found that prototypical networks with a convolutional embedding extractor performed better than other few-shot approaches. The use of a deeper embedding network like ResNet exhibited similar performance. In an effort to create a few-shot model with better generalization, another example incorporated an attention similarity module on top the few-shot models to ensure proper detection of onset and offset of sound events. Moreover, this example used synthetic background noise for creating a naturalistic setup. Still another example explicitly introduced a background class from an external dataset during training and a contrastive loss associated with the dataset so that the model could learn the background sound in addition to the target events. The results of this example indicated that models perform better when background samples are included in the support set at training, along with a target event. Due to the synthetic nature of the background sound, there might be a domain mismatch due to the difference of environment in various datasets. Therefore, including background sound class sourced within the training set may reduce the mismatch issue and improve detection performance.

As described above, previous examples in few-shot sound event detection mostly focus on training an efficient model, but ignore the processing required during inference time. Further examples explore the use of clustering in the support set during inference time to modify the general framework of prototypical network to solve a computer vision problem. Other examples attempt to reduce the intra-class variation within the support set. These examples are not used in few-shot sound event detection tasks, where background sounds tend to contain more variety than target sound. A single prototype for negative samples may be insufficient and clustering may be implemented to resolve this issue.

Accordingly, systems and methods according to the principles of the present disclosure implement various techniques to improve prototypical networks for SED (e.g., a first technique applied during training and three techniques applied during inference) by taking into account the variability of background sounds and automatically adapting to different testing scenarios.

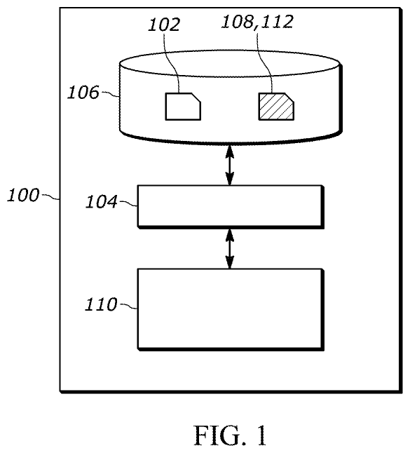

FIG. 1 shows one example system 100 for training a neural network (e.g., of an ML model). The system 100 may be configured to (and/or include circuitry configured to) implement the systems and methods of the present disclosure described below in more detail. The system 100 may comprise an input interface for accessing training data 102 for the neural network. For example, as illustrated in FIG. 1, the input interface may be constituted by a data storage interface 104 which may access the training data 102 from data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 106 may be an internal data storage of the system 100, such as a hard drive or SSD, but also external data storage, e.g., network-accessible data storage.

In some embodiments, the data storage 106 may further comprise a data representation 108 of an untrained version of the neural network which may be accessed by the system 100 from the data storage 106. It will be appreciated, however, that the training data 102 and the data representation 108 of the untrained neural network may also each be accessed from different data storage, e.g., via a different subsystem of the data storage interface 104. Each subsystem may be of a type as is described above for the data storage interface 104.

In some embodiments, the data representation 108 of the untrained neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive, as input, an output of a previous layer, or for a first layer of the stack of layers, an initial activation, and a part of the input of the stack of layers.

The processor subsystem 110 may be further configured to iteratively train the neural network using the training data 102. Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network.

The system 100 may further comprise an output interface for outputting a data representation 112 of the trained neural network, this data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ neural network may, during or after the training, be replaced, at least in part by the data representation 112 of the trained neural network, in that the parameters of the neural network, such as weights, hyperparameters and other types of parameters of neural networks, may be adapted to reflect the training on the training data 102. This is also illustrated in FIG. 1 by the reference numerals 108, 112 referring to the same data record on the data storage 106. In some embodiments, the data representation 112 may be stored separately from the data representation 108 defining the ‘untrained’ neural network. In some embodiments, the output interface may be separate from the data storage interface 104, but may in general be of a type as described above for the data storage interface 104.

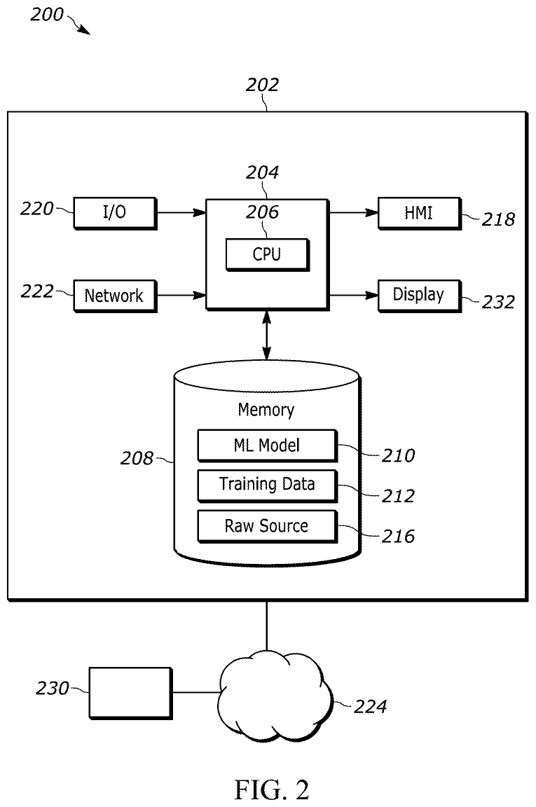

FIG. 2 depicts a data annotation/augmentation system 200 configured to (and/or including circuitry configured to) implement a system for annotating and/or augmenting data. The data annotation system 200 may include at least one computing system 202 configured to implement all or portions of the systems and methods of the present disclosure explained below in more detail. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction set such as one of the x86, ARM, Power, or MIPS instruction set families. Various components of the system 200 may be implemented with same or different circuitry.

During operation, the CPU 206 may execute stored program instructions that are retrieved from the memory unit 208. The stored program instructions may include software that controls operation of the CPU 206 to perform the operation described herein. In some embodiments, the processor 204 may be a system on a chip (SoC) that integrates functionality of the CPU 206, the memory unit 208, a network interface, and input/output interfaces into a single integrated device. The computing system 202 may implement an operating system for managing various aspects of the operation.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and FIG. 6 data. For example, the memory unit 208 may store a machine-learning model 210 (e.g., represented in FIG. 2 as the ML Model 210) or algorithm, a training dataset 212 for the machine-learning model 210, raw source dataset 216, etc.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud.

The external network 224 may be referred to as the world-wide web or the Internet. The external network 224 may establish a standard communication protocol between computing devices. The external network 224 may allow information and data to be easily exchanged between computing devices and networks. One or more servers 230 may be in communication with the external network 224.

The computing system 202 may include an input/output (I/O) interface 220 that may be configured to provide digital and/or analog inputs and outputs. The I/O interface 220 may include additional serial interfaces for communicating with external devices (e.g., Universal Serial Bus (USB) interface).

The computing system 202 may include a human-machine interface (HMI) device 218 that may include any device that enables the system 200 to receive control input. Examples of input devices may include human interface inputs such as keyboards, mice, touchscreens, voice input devices, and other similar devices. The computing system 202 may include a display device 232. The computing system 202 may include hardware and software for outputting graphics and text information to the display device 232. The display device 232 may include an electronic display screen, projector, printer or other suitable device for displaying information to a user or operator. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

The system 200 may implement a machine-learning model 210 that is configured to analyze the raw source dataset 216. For example, the CPU 206 and/or other circuitry may implement the machine-learning model 210. The raw source dataset 216 may include raw or unprocessed sensor data that may be representative of an input dataset for a machine-learning system. The raw source dataset 216 may include video, video segments, images, audio, text-based information, and raw or partially processed sensor data (e.g., radar map of objects). In some embodiments, the machine-learning model 210 may be a deep-learning or neural network algorithm that is designed to perform a predetermined function. For example, the neural network algorithm may be configured to identify events or objects in video segments based on audio data.

The computer system 200 may store the training dataset 212 for the machine-learning model 210. The training dataset 212 may represent a set of previously constructed data for training the machine-learning model 210. For example, the training dataset 212 according to the present disclosure may include multiple automatically-collected ground-truth measurements and associated data. The training dataset 212 may be used by the machine-learning model 210 to learn weighting factors associated with a neural network algorithm. The training dataset 212 may include a set of source data that has corresponding outcomes or results that the machine-learning model 210 tries to duplicate via the learning process.

The machine-learning model 210 may be operated in a learning mode using the training dataset 212 as input. The machine-learning model 210 may be executed over a number of iterations using the data from the training dataset 212. With each iteration, the machine-learning model 210 may update internal weighting factors based on the achieved results. For example, the machine-learning model 210 can compare output results (e.g., annotations) with those included in the training dataset 212. Since the training dataset 212 includes the expected results, the machine-learning model 210 can determine when performance is acceptable. After the machine-learning model 210 achieves a predetermined performance level (e.g., 100% agreement with the outcomes associated with the training dataset 212), the machine-learning model 210 may be executed using data that is not in the training dataset 212. The trained machine-learning model 210 may be applied to new datasets to generate annotated data.

The machine-learning model 210 may be configured to identify a particular feature in the raw source data 216. The raw source data 216 may include a plurality of instances or input dataset for which annotation results are desired (e.g., a video stream or segment including audio data). For example only, the machine-learning model 210 may be configured to identify objects or events in a video segment based on audio data and annotate the events. The machine-learning model 210 may be programmed to process the raw source data 216 to identify the presence of the particular features. The machine-learning model 210 may be configured to identify a feature in the raw source data 216 as a predetermined feature. The raw source data 216 may be derived from a variety of sources. For example, the raw source data 216 may be actual input data collected by a machine-learning system. The raw source data 216 may be machine generated for testing the system. As an example, the raw source data 216 may include raw video and/or audio data from a camera, audio data from a microphone, etc.

In an example, the machine-learning model 210 may process raw source data 216 and output video and/or audio data including one or more indications of an identified event. The machine-learning model 210 may generate a confidence level or factor for each output generated. For example, a confidence value that exceeds a predetermined high-confidence threshold may indicate that the machine-learning model 210 is confident that the identified event (or feature) corresponds to the particular event. A confidence value that is less than a low-confidence threshold may indicate that the machine-learning model 210 has some uncertainty that the particular feature is present.

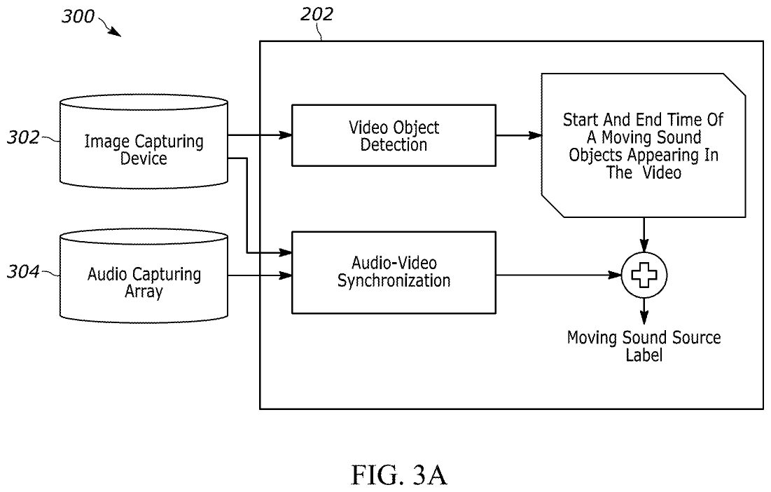

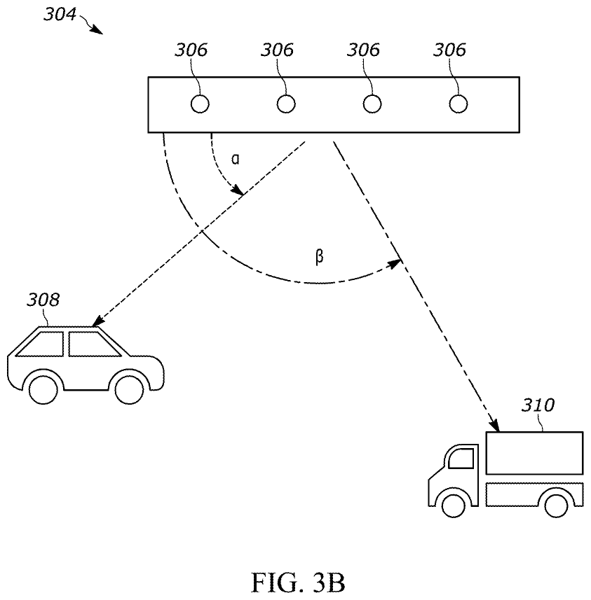

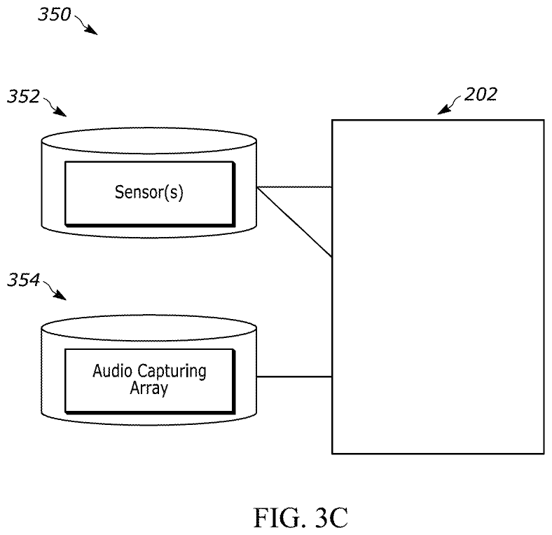

As is generally illustrated in FIGS. 3A and 3B, a system 300 may include an image (e.g., video) capturing device 302, an audio capturing array 304, and the computing system 202. The system may receive, from the image capturing device 302, video stream data associated with a data capture environment. The system 202 may be configured to perform video object detection to identify one or more objects in corresponding images of the video stream data. The system 202 may receive, from the audio capturing array 304, audio stream data that corresponds to at least a portion of the video stream data. The audio capturing array 304 may include one or more microphones 306 or other suitable audio capturing devices. The systems and methods described herein may be configured to label, using output from at least a first machine-learning model (e.g., such as the machine-learning model 210 or other suitable machine-learning model configured to provide output including one or more object or event detection predictions), at least some objects of the video stream data and/or audio stream data.

The system 202 may calculate (e.g., using at least one probabilistic-based function or other suitable technique or function), based on at least one data capturing characteristic, at least one offset value for at least a portion of the audio stream data that corresponds to at least one labeled object of the video stream data. The system 202 may synchronize, using at least the at least one offset value, at least a portion of the video stream data with the portion of the audio stream data that corresponds to the at least one labeled object of the video stream data. The at least one data capturing characteristic may include one or more characteristics of the at least one image capturing device, one or more characteristics of the at least one audio capturing array, one or more characteristics corresponding to a location of the at least one image capturing device relative to the at least one audio capturing array, one or more characteristics corresponding to a movement of an object in the video stream data, one or more other suitable data capturing characteristics, or a combination thereof.

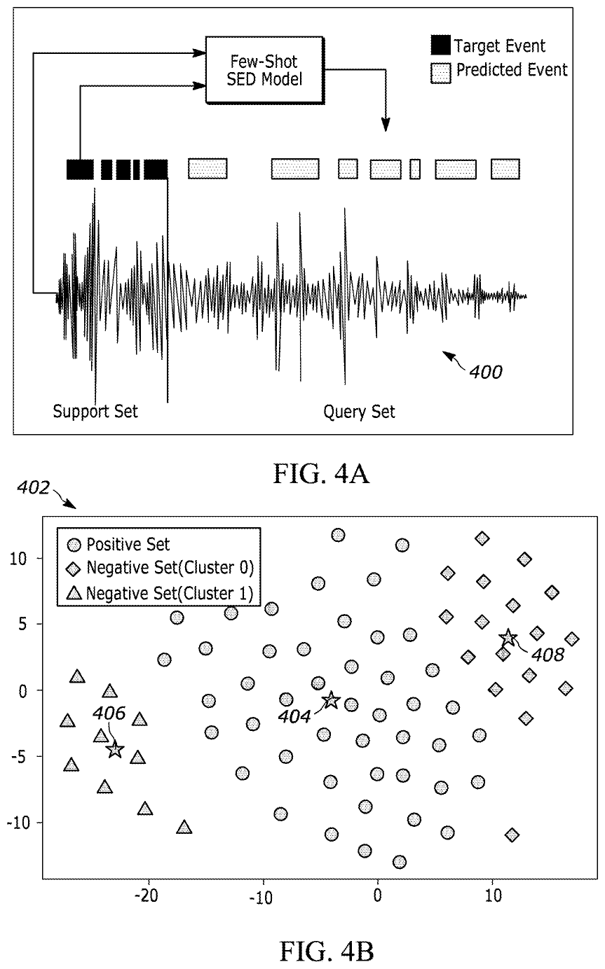

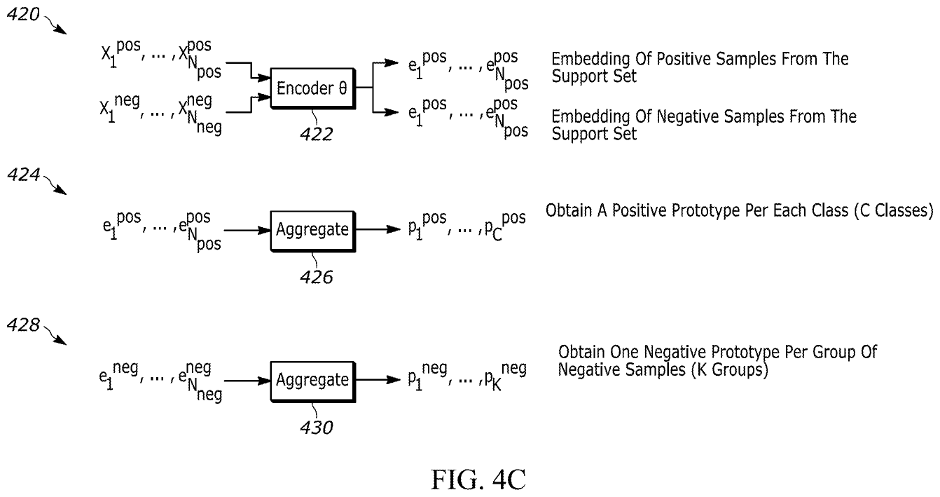

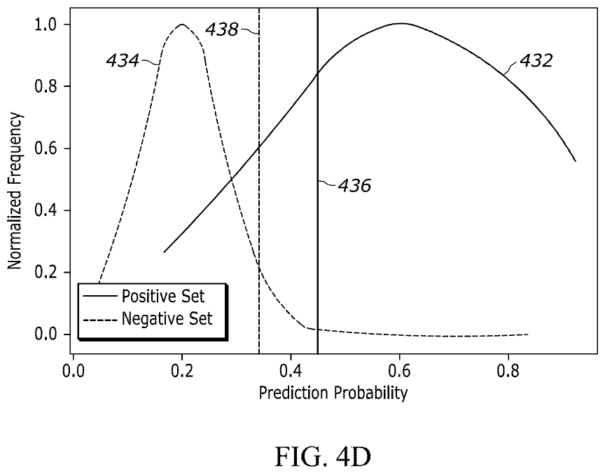

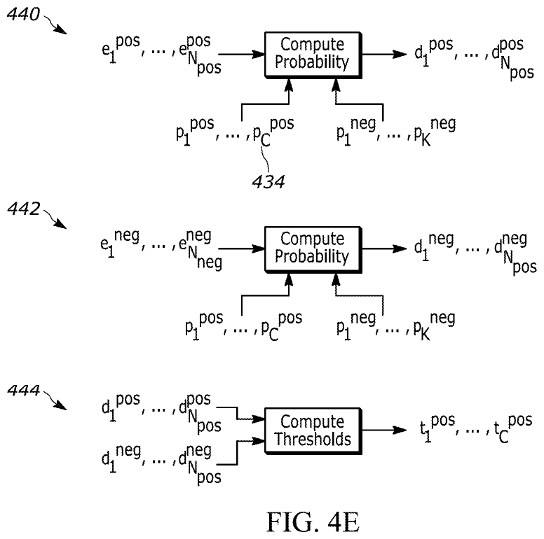

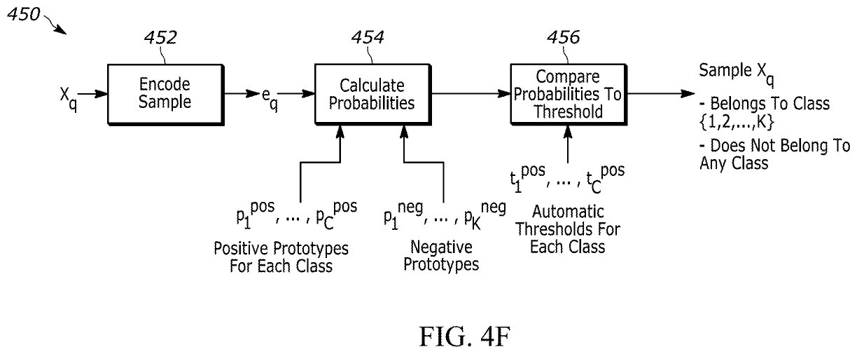

The system 202 may label, using one or more labels of the labeled objects of the video stream data and the at least one offset value, at least the portion of the audio stream data that corresponds to the at least one labeled object of the video stream data. Each respective label may include an event type, an event start indicator, and an event end indicator. The system 202 may generate training data using at least some of the labeled portion of the audio stream data. The system 202 may train a second machine-learning model using the training data. The system 202 may detect, using the second machine-learning model, one or more sounds associated with audio data provided as input to the second machine-learning model. The second machine-learning model may include any suitable machine-learning model and may be configured to perform any suitable function, such as those described herein with respect to FIGS. 4-11.

In some embodiments, as is generally illustrated in FIG. 3C, the computing system 202 may be configured to label audio data based on sensor data received from one or more sensors, such as those described herein or any other suitable sensor or combination of sensors. The system 202 may receive, from the audio capturing array 354 or any suitable audio capturing device, such as one or more of the microphones 306 or other suitable audio capturing device, audio stream data associated with a data capture environment. It should be understood that the audio capturing array 354 may include features similar to those of the audio capturing array 304 and may include any suitable number of audio capturing devices. The system 202 may receive, from at least one sensor (e.g., such as the sensor 352) that is asynchronous relative to the audio capturing array 354, sensor data associated with the data capture environment. The sensor 354 may include at least one of an induction coil, a radar sensor, a LiDAR sensor, a sonar sensor, an image capturing device, any other suitable sensor, or a combination thereof. The audio capturing array 354 may be remotely located from the sensor 354, proximately located to the sensor 354, or located in any suitable relationship to the sensor 354.

The system 202 may identify, using output from at least a first machine learning model, such as the machine learning model 210 or other suitable machine learning model, at least some events in the sensor data. The machine learning model 210 may be configured to provide output including one or more event detection predictions based on the sensor data. The system 202 may synchronize at least a portion of the sensor data associated with the portion of the audio stream data that corresponds to the at least one event of the sensor data. The system 202 may label, using one or more labels extracted for respective events of the sensor data value, at least the portion of the audio stream data that corresponds to the at least one event of the sensor data. Each respective label may include an event type, an event start indicator, and an event end indicator. The system 202 may generate training data using at least some of the labeled portion of the audio stream data. The system 202 may train a second machine-learning model using the training data. The system 202 may detect, using the second machine-learning model, one or more sounds associated with audio data provided as input to the second machine-learning model. The second machine-learning model may include any suitable machine-learning model and may be configured to perform any suitable function, such as those described herein with respect to FIGS. 4-11.

Any of the systems described above and/or below in more detail may implement systems and methods of the present disclosure to perform SED.

Prototypical networks learn the representation of different classes through support set examples. Using the embedding vectors for positive and negative samples in the support set, a prototype is formulated for each class as shown below in Equation (1):

$${c}_{pos} = \frac{1}{\vert {S}_{pos} \vert} {\sum }_{i = 1}^{\vert {S}_{pos} \vert} Θ ( {x}_{i}^{pos} )$$

$${c}_{neg} = \frac{1}{\vert {S}_{neg} \vert} {\sum }_{i = 1}^{\vert {S}_{neg} \vert} Θ ( {x}_{i}^{neg} ) ,$$

In Equation (1), Θ(⋅) represents a generic differentiable feature extractor that, given a sample at the input, produces its dimensional embedding as output. For a query sample x^{query}, the squared Euclidean distances between the query embedding and each class prototypes are calculated and the distances are passed through a softmax function to get the class probability distribution of the sample. The network is optimized by a stochastic gradient descent of the negative log-likelihood function.

To train the model in accordance with systems and methods of the present disclosure, an explicit background class is introduced during the training phase so that the model can learn a representation of both the target events and the background sounds. Instead of creating a synthetic background class, a background class is created from the given data. The background class is sampled from the unlabeled segments in X(t), t<t_{K}^{end}. Given y^{train}={(tᵢ^{start}, tᵢ^{end} yᵢ^{train})}, such that yᵢ^{train} □{1 . . . , C^{train}}, the time windows outside the range of tᵢ^{end} and tᵢ₊₁^{start} are marked as background class and they are provided a new label C^{train}+1. Therefore, the new training labels would be y^{train}={(tᵢ^{start}, tᵢ^{end}, yᵢ^{train})}∪{(tᵢ^{end}, tᵢ₊₁^{start}, C^{train}+1)}, such that yᵢ^{train}ϵ{1, . . . , C^{train}+1}.

Systems and methods according to the present disclosure are further configured to construct the negative support set using unlabeled segments from the support set. For example, typically the negative support set S_{neg} is constructed by random sampling segments from a whole audio stream (e.g., an audio stream 400 as shown in FIG. 4A, including the query set), assuming that the target sound events are sparse. However, the assumption that the target sound events are sparse might not be true for all the cases, and therefore systems and methods of the present disclosure construct S_{neg} using unlabeled segments from the support set (X^{test}(t), t<t_{K}^{end}) (i.e., from a known portion of the signal). Although this approach reduces the available number of negative segments to construct S_{neg}, the model is able to learn a better negative prototype using the refined S_{neg} without being contaminated by positive events randomly sampled from the whole audio sequence.

Systems and methods according to the present disclosure are further configured to cluster the negative support set during inference. In order to accommodate for diversity in the negative support set during inference time, we employ a k-means clustering algorithm on the embedding vectors obtained from the samples of the negative support set S_{neg}. In some examples, it may be assumed that the samples from the target sound events are more homogeneous than the negative samples. FIG. 4B shows a bi-dimensional t-SNE projection 402 obtained from the embeddings of positive and negative support sets for one audio sequence. The negative embeddings exhibit two distinct clusters (e.g., a negative set in clusters 0 and 1) while the positive embeddings are centered between the negative embeddings. By building only one prototype for the negative class, a query sample from this sequence might be easily misclassified due to the proximity of the resulting prototypes. As one example, k-means clustering is performed on the embeddings of the S_{neg} samples in each of the respective clusters 0 and 1, with an example value of k in the range 2 to 10. The value of k for which a highest Silhouette coefficient is obtained is then selected (e.g., 2 for the present example). Based on this observation, one positive prototype 404 and two negative prototypes 406, 408 are obtained for each audio stream. Accordingly, Equation (1) can be modified as follows:

$${e}_{neg}^{j} = \frac{1}{\vert {Γ}_{j} \vert} {\sum }_{Θ ( {x}_{1}^{neg} ) {ϵΓ}_{j}} Θ ( {x}_{1}^{neg} ) , j ϵ \{ 0 … k - 1 \} ,$$

where Γⱼ is the set of sample indices assigned to cluster j.

Further, instead of binary classification, the inference problem may be formulated as a K-shot ternary classification problem with one class for positive label and two classes for negative labels (e.g., as performed during inference, not during training).

FIG. 4C further illustrates example clustering of support sets according to the principles of the present disclosure. As shown at 420, positive samples x₁^{pos}, . . . x_{N}_{ₚₒₛ}^{pos} taken from the support set (e.g., from the known portion of the signal) are embedded/encoded (e.g., by encoder or encoding circuitry 422) into positive embeddings e₁^{pos}, . . . , e_{N}_{ₚₒₛ}^{pos}. Conversely, negative samples x₁^{neg}, . . . , x_{N}_{_{neg}}^{neg} taken from the support set are embedded/encoded into negative embeddings e₁^{neg}, . . . , e_{N}_{_{neg}}^{neg}.

As shown at 424, the positive embeddings are aggregated (e.g., by aggregator or aggregator circuitry 426) to obtain a positive prototype for each class p₁^{pos}, . . . , p_{C}^{pos}. For example, embeddings of positive samples from the same class may be averaged. Conversely, as shown at 428, the negative embeddings are aggregated (e.g., by aggregator or aggregator circuitry 430, which may be the same as or different from the aggregator 426) to obtain a negative prototype for each group of negative samples p₁^{neg}, . . . , p_{K}^{neg}. Typically, embeddings of negative samples are averaged into a single prototype (i.e., as one group). In contrast, in accordance with the principles of the present disclosure, the negative embeddings are clustered into K different groups and K different negative prototypes are obtained.

Systems and methods according to the present disclosure are further configured to perform automatic threshold identification. The class probability distribution of a query sample is obtained via softmax over the opposite of the Euclidean distances between the query embeddings and class prototypes. A query is classified to be a target sound event if the prediction probability for the positive class is over a threshold value. In some examples, the prediction probability value is empirically set to 0.5. In systems and methods according to the present disclosure, a computational approach is used to identify a threshold value that is customized for each audio sequence. For example, a leave-one-sample-out cross-validation approach is used on all the samples of the support set to estimate the probability distribution. Probability for a sample to be classified as a target event is calculated for each sample in the support set.

It may be assumed that probabilities obtained from S_{neg} would have a long tail on a right side of the distribution. Conversely, probabilities from Sₚₒₛ would have along tail on a left side of the distribution. Accordingly, two tail probabilities from these two distributions may be considered as the candidates for an evaluation threshold to reduce the false positive rate. In one example, a 95th percentile of the probabilities obtained from S_{neg} is considered a candidate since negative samples are greater in number. Conversely, a 25th percentile of the probabilities from Sₚₒₛ is considered as another candidate. The selection of the 25th percentile vs the 95th percentile is motivated by the limited number of positive samples in the support set.

FIG. 4D shows an example of the probability distributions obtained from positive support set samples 432 and negative support set samples 434 and their respective candidate thresholds (e.g., prediction probability thresholds) 436 and 438. The candidate threshold with a highest F-measure over the support set is taken as the evaluation threshold for the specific audio.

FIG. 4E further illustrates example probability calculations according to the principles of the present disclosure. For example, as shown at 440, probabilities d₁^{pos}, . . . , p_{N}_{ₚₒₛ}^{pos} that each of the positive samples e₁^{pos}, . . . , e_{N}_{ₚₒₛ}^{pos} belong to a given class p₁^{pos}, . . . , p_{C}^{pos} are obtained. The distribution of the values d₁^{pos}, . . . , d_{N}_{ₚₒₛ}^{pos} is shown as the solid line 432 in FIG. 4D. Conversely, as shown at 442, probabilities d₁^{neg}, . . . , d_{N}_{ₚₒₛ}^{neg} that each of the negative samples e₁^{neg}, . . . , e_{N}_{_{neg}}^{neg} belong to a given group p₁^{neg}, . . . , p_{K}^{neg} are obtained. The distribution of the values d₁^{neg}, . . . , d_{N}_{ₚₒₛ}^{neg} is shown as the dashed line 434 in FIG. 4D. As shown at 444, thresholds τ₁^{pos}, . . . , τ_{C}^{pos} are obtained for each class based on the distributions of d₁^{pos}, . . . , d_{N}_{ₚₒₛ}^{pos} and d₁^{neg}, . . . , d_{N}_{ₚₒₛ}^{neg}. The thresholds separate negative samples from positive samples.

FIG. 4F illustrates an example method 450 for determining a class of a sample x_{q} according to the principles of the present disclosure (e.g., as performed by any of the systems described in FIGS. 1-3 and 5-11). An encoded sample or embedding e_{q} of the sample is obtained at 452. A probability that the sample x_{q} belongs to a given class or group is calculated at 454 (e.g., based on the positive prototypes p₁^{pos}, . . . , p_{C}^{pos} and the negative prototypes p₁^{neg}, . . . , p_{K}^{neg}. The calculated probabilities are compared to the thresholds of each class τ₁^{pos}, . . . , τ_{C}^{pos} at 456. Accordingly, at 456, a determination is made as to whether the sample x_{q} belongs to a given class {1, 2, . . . , K} or does not belong to any class.

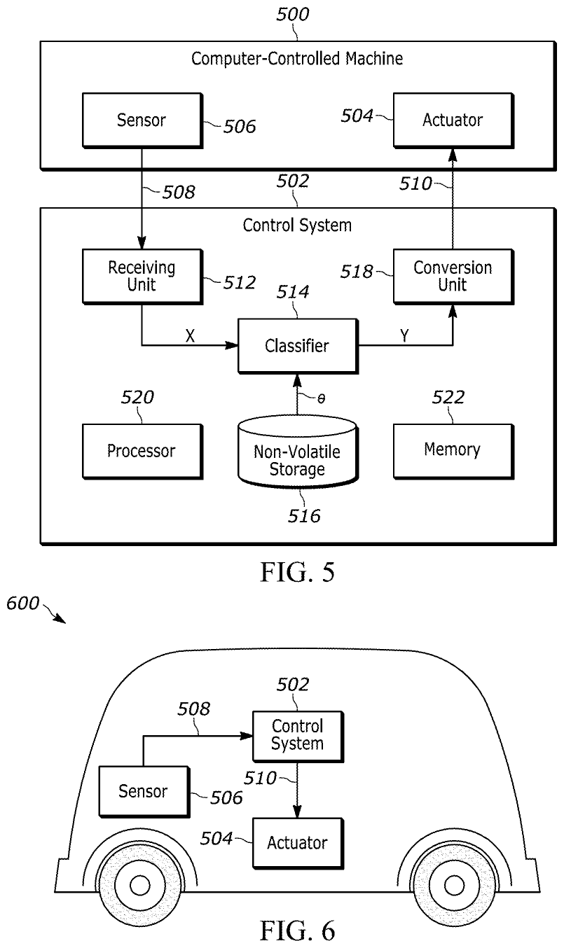

FIGS. 5-11 depict example systems and devices that may implement systems and methods according to the present disclosure. FIG. 5 depicts a schematic diagram of an interaction between computer-controlled machine 500 and control system 502. Computer-controlled machine 500 includes actuator 504 and sensor 506. Actuator 504 may include one or more actuators and sensor 506 may include one or more sensors. Sensor 506 is configured to sense a condition of computer-controlled machine 500. Sensor 506 may be configured to encode the sensed condition into sensor signals 508 and to transmit sensor signals 508 to control system 502. Non-limiting examples of sensor 506 include video, radar, LiDAR, ultrasonic and motion sensors. In some embodiments, sensor 506 is an optical sensor configured to sense optical images of an environment proximate to computer-controlled machine 500.

Control system 502 is configured to receive sensor signals 508 from computer-controlled machine 500. As set forth below, control system 502 may be further configured to compute actuator control commands 510 depending on the sensor signals and to transmit actuator control commands 510 to actuator 504 of computer-controlled machine 500.

As shown in FIG. 5, control system 502 includes receiving unit 512. Receiving unit 512 may be configured to receive sensor signals 508 from sensor 506 and to transform sensor signals 508 into input signals x. In an alternative embodiment, sensor signals 508 are received directly as input signals x without receiving unit 512. Each input signal x may be a portion of each sensor signal 508. Receiving unit 512 may be configured to process each sensor signal 508 to product each input signal x. Input signal x may include data corresponding to an image recorded by sensor 506.

Control system 502 includes classifier 514. Classifier 514 may be configured to classify input signals x into one or more labels using a machine-learning (ML) algorithm, such as a neural network described above. Classifier 514 is configured to be parametrized by parameters, such as those described above (e.g., parameter θ). Parameters θ may be stored in and provided by non-volatile storage 516. Classifier 514 is configured to determine output signals y from input signals x. Each output signal y includes information that assigns one or more labels to each input signal x. Classifier 514 may transmit output signals y to conversion unit 518. Conversion unit 518 is configured to covert output signals y into actuator control commands 510. Control system 502 is configured to transmit actuator control commands 510 to actuator 504, which is configured to actuate computer-controlled machine 500 in response to actuator control commands 510. In some embodiments, actuator 504 is configured to actuate computer-controlled machine 500 based directly on output signals y.

Upon receipt of actuator control commands 510 by actuator 504, actuator 504 is configured to execute an action corresponding to the related actuator control command 510. Actuator 504 may include a control logic configured to transform actuator control commands 510 into a second actuator control command, which is utilized to control actuator 504. In one or more embodiments, actuator control commands 510 may be utilized to control a display instead of or in addition to an actuator.

In some embodiments, control system 502 includes sensor 506 instead of or in addition to computer-controlled machine 500 including sensor 506. Control system 502 may also include actuator 504 instead of or in addition to computer-controlled machine 500 including actuator 504.

As shown in FIG. 5, control system 502 also includes processor 520 and memory 522. Processor 520 may include one or more processors. Memory 522 may include one or more memory devices. The classifier 514 (e.g., ML algorithms) of one or more embodiments may be implemented by control system 502, which includes non-volatile storage 516, processor 520 and memory 522.

Non-volatile storage 516 may include one or more persistent data storage devices such as a hard drive, optical drive, tape drive, non-volatile solid-state device, cloud storage or any other device capable of persistently storing information. Processor 520 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 522. Memory 522 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 520 may be configured to read into memory 522 and execute computer-executable instructions residing in non-volatile storage 516 and embodying one or more ML algorithms and/or methodologies of one or more embodiments. Non-volatile storage 516 may include one or more operating systems and applications. Non-volatile storage 516 may store compiled and/or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

Upon execution by processor 520, the computer-executable instructions of non-volatile storage 516 may cause control system 502 to implement one or more of the ML algorithms and/or methodologies as disclosed herein. Non-volatile storage 516 may also include ML data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

FIG. 6 depicts a schematic diagram of control system 502 configured to control vehicle 600, which may be an at least partially autonomous vehicle or an at least partially autonomous robot. Vehicle 600 includes actuator 504 and sensor 506. Sensor 506 may include one or more video sensors, cameras, radar sensors, ultrasonic sensors, LiDAR sensors, and/or position sensors (e.g. GPS). To implement systems and methods according to the present disclosure, the sensor 506 may include at least one audio sensor (e.g., a microphone) and the control system 502 is configured to detect sound events in a vicinity of the vehicle 600. As one example, the control system 502 may be configured to control autonomous functions, such as navigation, of the vehicle 600 responsive to detected sound events.

One or more of the one or more specific sensors may be integrated into vehicle 600. Alternatively or in addition to one or more specific sensors identified above, sensor 506 may include a software module configured to, upon execution, determine a state of actuator 504. One non-limiting example of a software module includes a weather information software module configured to determine a present or future state of the weather proximate vehicle 600 or other location.

Classifier 514 of control system 502 of vehicle 600 may be configured to detect objects in the vicinity of vehicle 600 dependent on input signals x. In such an embodiment, output signal y may include information characterizing the vicinity of objects to vehicle 600. Actuator control command 510 may be determined in accordance with this information. The actuator control command 510 may be used to avoid collisions with the detected objects.

In some embodiments, the vehicle 600 is an at least partially autonomous vehicle, actuator 504 may be embodied in a brake, a propulsion system, an engine, a drivetrain, or a steering of vehicle 600. Actuator control commands 510 may be determined such that actuator 504 is controlled such that vehicle 600 avoids collisions with detected objects. Detected objects may also be classified according to what classifier 514 deems them most likely to be, such as pedestrians or trees. The actuator control commands 510 may be determined depending on the classification. In a scenario where an adversarial attack may occur, the system described above may be further trained to better detect objects or identify a change in lighting conditions or an angle for a sensor or camera on vehicle 600.

In some embodiments where vehicle 600 is an at least partially autonomous robot, vehicle 600 may be a mobile robot that is configured to carry out one or more functions, such as flying, swimming, diving and stepping. The mobile robot may be an at least partially autonomous lawn mower or an at least partially autonomous cleaning robot. In such embodiments, the actuator control command 510 may be determined such that a propulsion unit, steering unit and/or brake unit of the mobile robot may be controlled such that the mobile robot may avoid collisions with identified objects.

In some embodiments, vehicle 600 is an at least partially autonomous robot in the form of a gardening robot. In such embodiment, vehicle 600 may use an optical sensor as sensor 506 to determine a state of plants in an environment proximate vehicle 600. Actuator 504 may be a nozzle configured to spray chemicals. Depending on an identified species and/or an identified state of the plants, actuator control command 510 may be determined to cause actuator 504 to spray the plants with a suitable quantity of suitable chemicals.

Vehicle 600 may be an at least partially autonomous robot in the form of a domestic appliance. Non-limiting examples of domestic appliances include a washing machine, a stove, an oven, a microwave, or a dishwasher. In such a vehicle 600, sensor 506 may be an optical sensor configured to detect a state of an object which is to undergo processing by the household appliance. For example, in the case of the domestic appliance being a washing machine, sensor 506 may detect a state of the laundry inside the washing machine. Actuator control command 510 may be determined based on the detected state of the laundry.

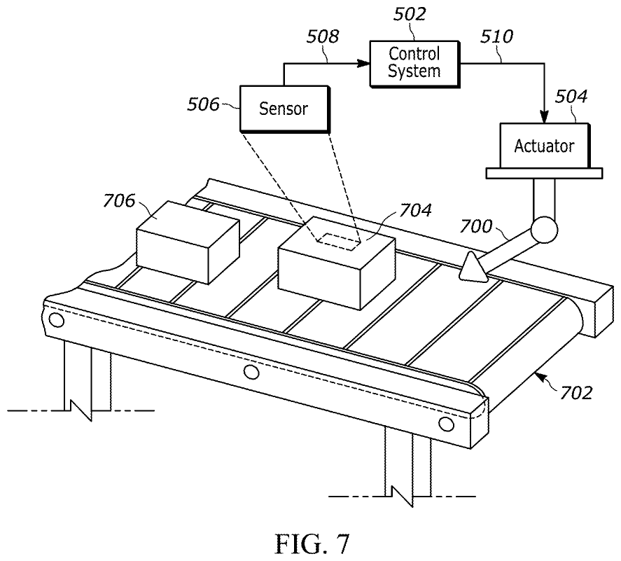

FIG. 7 depicts a schematic diagram of control system 502 configured to control system 700 (e.g., manufacturing machine), such as a punch cutter, a cutter or a gun drill, of manufacturing system 702, such as part of a production line. Control system 502 may be configured to control actuator 504, which is configured to control system 700 (e.g., manufacturing machine).

Sensor 506 of system 700 (e.g., manufacturing machine) may be an optical sensor configured to capture one or more properties of manufactured product 704. To implement systems and methods according to the present disclosure, the sensor 506 may include at least one audio sensor (e.g., a microphone) and the control system 502 is configured to detect sound events related to operation of manufacturing machine in a manufacturing facility. Classifier 514 may be configured to determine a state of manufactured product 704 from one or more of the captured properties, such as detected sound events. Actuator 504 may be configured to control system 700 (e.g., manufacturing machine) depending on the determined state of manufactured product 704 for a subsequent manufacturing step of manufactured product 704. The actuator 504 may be configured to control functions of system 700 (e.g., manufacturing machine) on subsequent manufactured product 706 of system 700 (e.g., manufacturing machine) depending on the determined state of manufactured product 704.

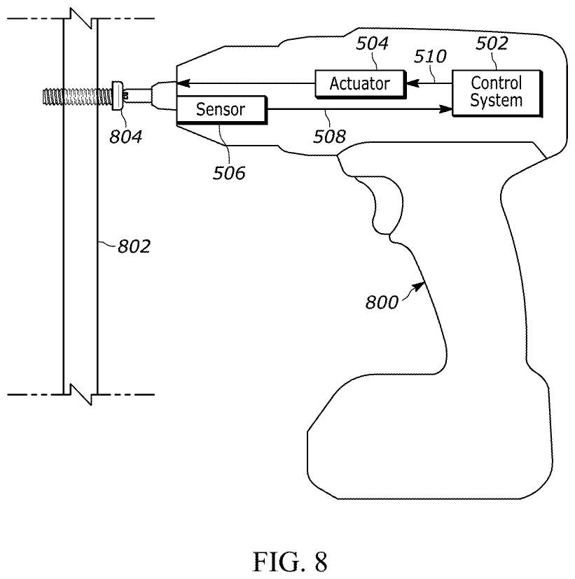

FIG. 8 depicts a schematic diagram of control system 502 configured to control power tool 800, such as a power drill or driver, that has an at least partially autonomous mode. Control system 502 may be configured to control actuator 504, which is configured to control power tool 800.

Sensor 506 of power tool 800 may be an optical sensor configured to capture one or more properties of work surface 802 and/or fastener 804 being driven into work surface 802. To implement systems and methods according to the present disclosure, the sensor 506 may include at least one audio sensor (e.g., a microphone) and the control system 502 is configured to detect sound events related to operation of the power tool 800. Classifier 514 may be configured to determine a state of work surface 802 and/or fastener 804 relative to work surface 802 from one or more of the captured properties, such as detected sound events. The state may be fastener 804 being flush with work surface 802. The state may alternatively be hardness of work surface 802. Actuator 504 may be configured to control power tool 800 such that the driving function of power tool 800 is adjusted depending on the determined state of fastener 804 relative to work surface 802 or one or more captured properties of work surface 802. For example, actuator 504 may discontinue the driving function if the state of fastener 804 is flush relative to work surface 802. As another non-limiting example, actuator 504 may apply additional or less torque depending on the hardness of work surface 802.

FIG. 9 depicts a schematic diagram of control system 502 configured to control automated personal assistant 900. Control system 502 may be configured to control actuator 504, which is configured to control automated personal assistant 900. Automated personal assistant 900 may be configured to control a domestic appliance, such as a washing machine, a stove, an oven, a microwave or a dishwasher.

Sensor 506 may be an optical sensor and/or an audio sensor. The optical sensor may be configured to receive video images of gestures 904 of user 902. The audio sensor may be configured to receive a voice command of user 902. To implement systems and methods according to the present disclosure, the control system 502 is configured to detect sound events in a vicinity of the automated personal assistant 900, such as sound events associated with operation of appliances controlled by the automated personal assistant 900.

Control system 502 of automated personal assistant 900 may be configured to determine actuator control commands 510 configured to control system 502. Control system 502 may be configured to determine actuator control commands 510 in accordance with sensor signals 508 of sensor 506. Automated personal assistant 900 is configured to transmit sensor signals 508 to control system 502. Classifier 514 of control system 502 may be configured to execute a gesture recognition algorithm to identify gesture 904 made by user 902, to determine actuator control commands 510, and to transmit the actuator control commands 510 to actuator 504. Classifier 514 may be configured to retrieve information from non-volatile storage in response to gesture 904 and to output the retrieved information in a form suitable for reception by user 902.

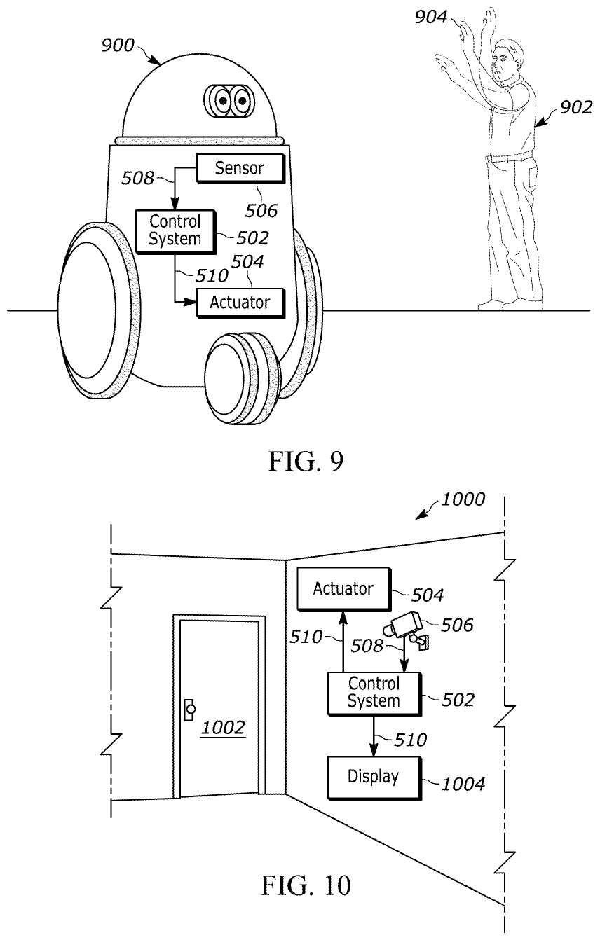

FIG. 10 depicts a schematic diagram of control system 502 configured to control monitoring system 1000. Monitoring system 1000 may be configured to physically control access through door 1002. Sensor 506 may be configured to detect a scene that is relevant in deciding whether access is granted. Sensor 506 may be an optical sensor configured to generate and transmit image and/or video data. Such data may be used by control system 502 to detect a person's face. To implement systems and methods according to the present disclosure, the sensor 506 may include at least one audio sensor (e.g., a microphone) and the control system 502 is configured to detect sound events in a vicinity of the monitoring system 1000, such as sound events caused by people attempting to access the door 1002. As one example, the control system 502 may be configured to prevent or allow access through the door 1002 responsive to detected sound events.

Classifier 514 of control system 502 of monitoring system 1000 may be configured to interpret the image and/or video data by matching identities of known people stored in non-volatile storage 516, thereby determining an identity of a person. Classifier 514 may be configured to generate and an actuator control command 510 in response to the interpretation of the image and/or video data. Control system 502 is configured to transmit the actuator control command 510 to actuator 504. In this embodiment, actuator 504 may be configured to lock or unlock door 1002 in response to the actuator control command 510. In some embodiments, a non-physical, logical access control is also possible.

Monitoring system 1000 may also be a surveillance system. In such an embodiment, sensor 506 may be an optical sensor configured to detect a scene that is under surveillance and control system 502 is configured to control display 1004. Classifier 514 is configured to determine a classification of a scene, e.g. whether the scene detected by sensor 506 is suspicious. Control system 502 is configured to transmit an actuator control command 510 to display 1004 in response to the classification. Display 1004 may be configured to adjust the displayed content in response to the actuator control command 510. For instance, display 1004 may highlight an object that is deemed suspicious by classifier 514. Utilizing an embodiment of the system disclosed, the surveillance system may predict objects at certain times in the future showing up.

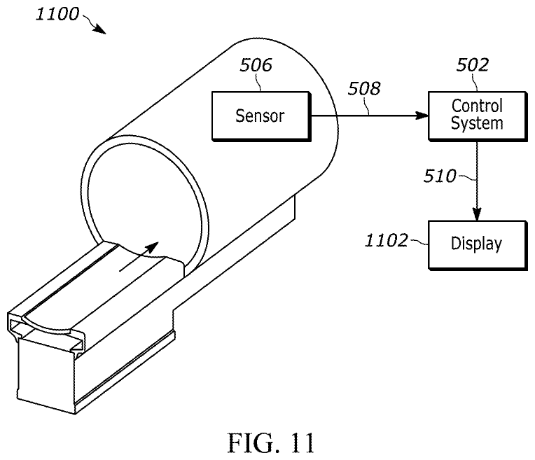

FIG. 11 depicts a schematic diagram of control system 502 configured to control imaging system 1100, for example an MRI apparatus, x-ray imaging apparatus or ultrasonic apparatus. Sensor 506 may, for example, be an imaging sensor. To implement systems and methods according to the present disclosure, the sensor 506 may include at least one audio sensor (e.g., a microphone) and the control system 502 is configured to detect sound events in a vicinity of the imaging system 1100, such as sounds caused by operation of the imaging system 1100, users of the imaging system 1100, etc. As one example, the control system 502 may be configured to pause, interrupt, continue, etc. an imaging procedure responsive to detected sound events. Classifier 514 may be configured to determine a classification of all or part of the sensed image. Classifier 514 may be configured to determine or select an actuator control command 510 in response to the classification obtained by the trained neural network. For example, classifier 514 may interpret a region of a sensed image to be potentially anomalous. In this case, actuator control command 510 may be determined or selected to cause display 1102 to display the imaging and highlighting the potentially anomalous region.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method of training a prototypical network for sound event detection, the method comprising:
receiving samples of an audio signal, wherein the samples include positive samples corresponding to sound events and negative samples that do not correspond to sound events;
determining, based on the positive samples, respective positive prototypes of a plurality of classes of sound events;
determining, based on the negative samples, respective negative prototypes for respective groups of the negative samples, wherein each of the negative prototypes corresponds to a combination of a plurality of the negative samples; and
generating, based on comparisons between (i) a first sample and (ii) the respective positive prototypes and each of the negative prototypes, an output signal that indicates whether a first sample belongs to one of the plurality of classes of sound events.

2. The method of claim 1, further comprising:
obtaining first embeddings of the positive samples and second embeddings of the negative samples;
determining the respective positive prototypes based on the first embeddings; and
determining the respective negative prototypes based on the second embeddings.

3. The method of claim 1, wherein determining the respective negative prototypes includes determining a negative prototype for each of the respective groups of the negative samples.

4. The method of claim 1, further comprising:
determining, based on the comparisons, at least one probability that the first sample corresponds to the one of the plurality of classes of sound events; and
generating the output based on the at least one probability.

5. The method of claim 4, further comprising:
determining at least one probability distribution; and
generating the output based on the at least one probability distribution.

6. The method of claim 5, further comprising:
determining at least one threshold based on the at least one probability distribution; and
generating the output based on a comparison between the at least one probability and the at least one threshold.

7. The method of claim 6, wherein determining the at least one threshold includes determining the at least one threshold based on (i) a first probability distribution of probabilities that the positive samples belong to respective classes of the plurality of classes of sound events and (ii) a second distribution of probabilities that the negative samples belong to respective classes of the plurality of classes of sound events.

8. A computing device configured to train a prototypical network for sound event detection, the computing device including a processing device configured to execute instructions stored in memory to:
receive samples of an audio signal, wherein the samples include positive samples corresponding to sound events and negative samples that do not correspond to sound events;
determine, based on the positive samples, respective positive prototypes of a plurality of classes of sound events;
determine, based on the negative samples, respective negative prototypes for respective groups of the negative samples, wherein each of the negative prototypes corresponds to a combination of a plurality of the negative samples; and
generate, based on comparisons between (i) a first sample and (ii) the respective positive prototypes and each of the negative prototypes, an output signal that indicates whether the first sample belongs to one of the plurality of classes of sound events.

9. The computing device of claim 8, wherein the processing device is further configured to execute the instructions to:
obtain first embeddings of the positive samples and second embeddings of the negative samples;
determine the respective positive prototypes based on the first embeddings; and
determine the respective negative prototypes based on the second embeddings.

10. The computing device of claim 8, wherein determining the respective negative prototypes includes determining a negative prototype for each of the respective groups of the negative samples.

11. The computing device of claim 8, wherein the processing device is further configured to execute the instructions to:
determine, based on the comparisons, at least one probability that the first sample corresponds to the one of the plurality of classes of sound events; and
generate the output based on the at least one probability.

12. The computing device of claim 11, wherein the processing device is further configured to execute the instructions to:
determine at least one probability distribution; and
generate the output based on the at least one probability distribution.

13. The computing device of claim 12, wherein the processing device is further configured to execute the instructions to:
determine at least one threshold based on the at least one probability distribution; and
generate the output based on a comparison between the at least one probability and the at least one threshold.

14. The computing device of claim 13, wherein determining the at least one threshold includes determining the at least one threshold based on (i) a first probability distribution of probabilities that the positive samples belong to respective classes of the plurality of classes of sound events and (ii) a second distribution of probabilities that the negative samples belong to respective classes of the plurality of classes of sound events.

15. A computer-controlled machine, comprising:
at least one sensor configured to generate an audio signal;
a control system configured to
receive a first sample of the audio signal, and
generate, based on comparisons between the (i) the first sample and (ii) respective positive prototypes for each of a plurality of classes of sound events and respective negative prototypes for each of a plurality of groups of negative prototypes, an output signal that indicates whether the first sample of the audio signal belongs to one of the plurality of classes of sound events; and
an actuator configured to control an operation of the computer-controlled machine in response to the output of the control system.

16. The computer-controlled machine of claim 15, further comprising memory that stores the respective positive prototypes and the respective negative prototypes, wherein:
the respective positive prototypes correspond to a plurality of positive samples; and
each of the respective negative prototypes corresponds to a combination of a plurality of negative samples.

17. The computer-controlled machine of claim 15, wherein generating the output includes calculating a probability that the first sample belongs to a first class of the plurality of classes of sound events or a first group of the plurality of groups.

18. The computer-controlled machine of claim 17, wherein generating the output includes comparing the probability to at least one threshold and generating the output based on the comparison.

19. The computer-controlled machine of claim 18, wherein the at least one threshold includes a plurality of thresholds corresponding to respective classes of the plurality of classes of sound events.

20. The computer-controlled machine of claim 15, wherein the computer-controlled machine includes an autonomous robot.
